(19) United States
(12) Patent Application Publication
(10) Pub. No.: US 2025/0286289 A1
(43) Pub. Date: Sep. 11, 2025

(54) MULTI-TAP MECHANICAL SHEAR BOLT INSULATION PIERCING CONNECTORS

(71) Applicant: Hubbell Incorporated, Shelton, CT (US)

(72) Inventors: Richard Ernest Robicheau, Litchfield, NH (US); Andrew Roland Stokes, Gilford, NH (US)

(21) Appl. No.: 19/072,358

(22) Filed: Mar. 6, 2025

Related U.S. Application Data
(60) Provisional application No. 63/561,944, filed on Mar. 6, 2024.
(60) Provisional application No. 63/730,704, filed on Dec. 11, 2024.

(51) Int. Cl. H01R 4/2483

(52) U.S. Cl. CPC H01R 4/2483

(57) ABSTRACT

A connector includes a conductor block with a run line opening, a run insulation piercing member extending into the run line opening, a tap line opening, and a tap insulation piercing member extending into the tap line opening. A run cap extends over the run line opening. A run bolt extends through the run cap into the run line opening. The run bolt includes a first threaded shank and a first shearable head. The first shearable head is configured to disconnect from the first threaded shank on reaching a first torque limit. A tap cap extends over the tap line opening. A tap bolt extends through the tap cap into the tap line opening. The tap bolt includes a second threaded shank and a second shearable head. The second shearable head is configured to disconnect from the second threaded shank on reaching a second torque limit.

### RELATED APPLICATION(S)

This application is based on U.S. Provisional Application Ser. No. 63/561,944, filed Mar. 6, 2024 and U.S. Provisional Application Ser. No. 63/730,704, filed Dec. 11, 2024, the disclosure of which is incorporated herein by reference in its entirety and to which priority is claimed.

### FIELD

The present disclosure relates to electrical connectors used to connect a main or run conductor with one or more tap conductors.

### BACKGROUND

Electrical connectors exist in various forms including terminals, splices and run and taps. Tap connectors can be used to establish an electrical connection between a continuous run or main power conductor to a tap or branch conductor. Existing compression connectors are typically adapted to receive a branch or tap conductor, to engage a continuous run conductor, and to be compressed by means of a crimping tool to achieve the desired connection.

Compression connectors can include insulation piercing teeth that will pierce the non-conductive, outer insulation layer of a conductor to contact the inner core. The core can be a solid or stranded wire made from an electrically conductive material. Use of insulation piercing teeth can reduce or eliminate the need to strip conductors prior to making a connection and eliminate the need to secure connections with a joining material such as solder.

### SUMMARY

Certain configurations are directed to an electrical connector for connecting a plurality of conductors. The connector includes a conductor block having a body with a run line opening, a run insulation piercing member extending into the run line opening, a tap line opening, and a tap insulation piercing member extending into the tap line opening. A run cap extends over the run line opening. A run bolt extends through the run cap into the run line opening. The run bolt includes a first threaded shank and a first shearable head. The first shearable head is configured to disconnect from the first threaded shank on reaching a first torque limit. A tap cap extends over the tap line opening. A tap bolt extends through the tap cap into the tap line opening. The tap bolt includes a second threaded shank and a second shearable head. The second shearable head is configured to disconnect from the second threaded shank on reaching a second torque limit.

Certain configurations are directed to an electrical connector for connecting a plurality of conductors. The connector includes a conductor block having a body with a run line opening, a run insulation piercing member extending into the run line opening, a run guide slot extending from the run line opening, a tap line opening, a tap insulation piercing member extending into the tap line opening, and a tap guide slot extending from the tap line opening. A run cap is connected to the conductor block via the run guide slot. A run bolt extends through the run cap into the run line opening. The run bolt includes a first threaded shank and a first shearable head. The first shearable head is configured to disconnect from the first threaded shank on reaching a first torque limit. A tap cap is connected to the conductor block via the tap guide slot. A tap bolt extends through the tap cap into the tap line opening. The tap bolt includes a second threaded shank and a second shearable head. The second shearable head is configured to disconnect from the second threaded shank on reaching a second torque limit.

Certain implementations are directed to a method of connecting a plurality of electrical conductors. A tap conductor is inserted into a tap line opening of a conductor block. A tap bolt is rotated to engage the tap conductor. The tap conductor is driven into a tap insulation piercing member extending into the tap line opening. The tap bolt is rotated until a first torque limit is reached and a head of the tap bolt is sheared off. A run conductor is inserted into a run line opening of the conductor block. A run bolt is rotated to engage the run conductor. The run conductor is driven into a run insulation piercing member extending into the run line opening. The run bolt is rotated until a second torque limit is reached and a head of the run bolt is sheared off.

Certain configurations are directed to an electrical connector for connecting a plurality of conductors. A conductor block includes a body with a run line opening, a run insulation piercing member extending into the run line opening, a tap line opening, and a tap insulation piercing member extending into the tap line opening. A run cap extends over the run line opening. A run bolt extends through the run cap into the run line opening. The run bolt includes a first threaded shank and a first shearable head. The first shearable head is configured to disconnect from the first threaded shank on reaching a first torque limit. A tap bolt extends through the conductor block into the tap line opening.

### BRIEF DESCRIPTION OF THE DRAWINGS

The aspects and features of various exemplary embodiments will be more apparent from the description of those exemplary embodiments taken with reference to the accompanying drawings.

FIG. 1 is a perspective view of an exemplary configuration of a multi-tap electrical connector.

FIG. 2 is a front view of the connector of FIG. 1.

FIG. 3 is a top view of the connector of FIG. 1.

FIG. 4 is a front, exploded view of the connector of FIG. 1.

FIG. 5 is a perspective view of another exemplary configuration of a multi-tap electrical connector.

FIG. 6 is a front, exploded view of the connector of FIG. 5.

FIG. 7 is a perspective view of another exemplary configuration of a multi-tap electrical connector.

FIG. 8 is a bottom perspective view of the connector of FIG. 7.

FIG. 9 is a front, exploded view of the connector of 7.

FIG. 10 is a front view of another exemplary configuration of a multi-tap electrical connector.

FIG. 11 is a front view of another exemplary configuration of a multi-tap electrical connector.

FIG. 12 is a front view of another exemplary configuration of a multi-tap electrical connector.

FIG. 13 is a perspective view of another exemplary configuration of a multi-tap electrical connector.

FIG. 14 is a front view of FIG. 13.

FIG. 15 is an exploded view of FIG. 14.

FIG. 16 is a perspective view of another exemplary configuration of a multi-tap electrical connector.

FIG. 17 is a front view of FIG. 16.

FIG. 18 is an exploded view of FIG. 17.

FIG. 19 is a perspective view of another exemplary configuration of a multi-tap electrical connector.

FIG. 20 is a front view of FIG. 19.

FIG. 21 is an exploded view of FIG. 20.

### DETAILED DESCRIPTION OF EXEMPLARY EMBODIMENTS

Tap connectors are used in different electrical distribution applications. Tap connectors are used to transfer electrical power between one or more conductors. For example, a primary, main, or run conductor and one or more secondary, branch, or tap conductors are physically and electrically connected, such as a distribution block, terminal lug, splice, or other connector. Power is transferred between the primary conductor and the tap conductors.

For example, tap conductors can be used in solar power generation facilities to help distribute power from individual solar panels to a main trunk line. Each panel or an array of panels can generate power which is fed to a junction box. Conductors are run from the junction box and can be connected to a combiner box. The combiner box combines the electrical outputs from multiple strings of panels into a single output. The main trunk line, also known as the bus bar, is a heavy-duty cable or set of cables that runs along the rows of solar panels. It collects the combined electrical output from all the parallel strings in the array. The trunk line typically carries the DC electricity to a central location, such as an inverter station or a substation, for further processing or distribution. The inverter converts the DC electricity from the solar panels into AC electricity suitable for grid connection or use in a local network.

As demand for solar power grows, installations generating solar power are trending toward larger footprints and larger production capacity. However, scaling solar farm capacity also grows complexity. Costs associated with installation, operation, and maintenance grow. Field terrain and other factors can challenge photovoltaic module layouts, requiring flexibility for connecting these installations. Accordingly, being able to produce flexible, repeatable, and reliable connections in a distribution system, such as a solar farm, offers a number of benefits.

Certain implementations are directed to connectors that are configured to connect a run line to multiple tap lines. Certain configurations can utilize insulation piercing teeth in one or both of the run lines and tap lines so that the need to strip conductors prior to installation is reduced or eliminated. Compression connectors with insulation piercing teeth are described in U.S. application Ser. No. 18/211,102, published as US 2023/0411871, the disclosure of which is hereby incorporated by reference in its entirety.

Run conductors are typically greater in size than the tap conductors. The run conductors and the tap conductors can be solid conductors, or they can be stranded conductors. Typically, the run conductors and tap conductors are stranded conductors. Different sizes and types of conductors can be used. Further, while the terms run/main/trunk conductors and secondary/tap/branch conductors may be used, the connectors described are suitable for mechanically and electrically joining any one conductor to any one or more other conductors regardless of the type of conductor or implementation of the power system.

The connections can be secured by regular bolt connectors or shear bolt connectors. The shear bolt can include a head connected to a threaded shaft by a shearable section. The shearable section can be a weakened area designed to break or otherwise separate once a certain torque limit is reached. As the fastener is rotated, the shaft or an associated pressure bar will engage a conductor. As the fastener is tightened, the engagement with the conductor will increase the amount of torque required to further turn the fastener. Once the torque limit is reached, the head will shear, separating from the fastener. This ensures a certain connection engagement is achieved with the conductor, while also preventing overtightening that could damage the conductor.

Use of shear bolt connectors can be accomplished with standard tooling, such as an electric impact driver. This can eliminate the need to use more complex tooling, such as a power crimping tool, which can be heavier and more expensive.

Use of these types of connectors can provide a number of advantages. In any electrical distribution system they can increase the flexibility of the system design and reduce the need for complex tooling and installation procedures. They can also increase the repeatability and reliability of connections. In solar panel installations they can also eliminate the need for combiner boxes, allowing panels to be more directly connected to a trunk line.

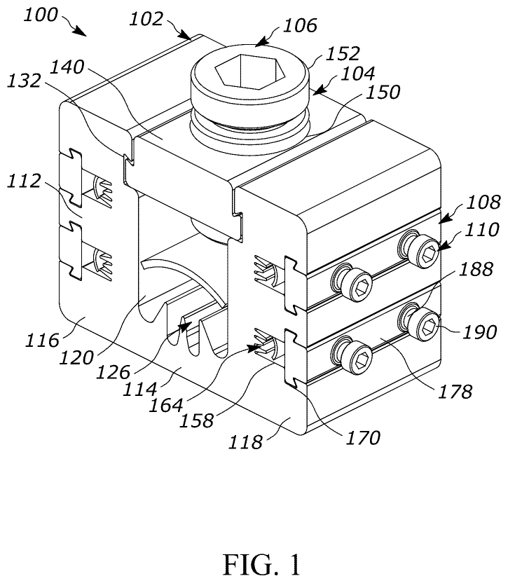

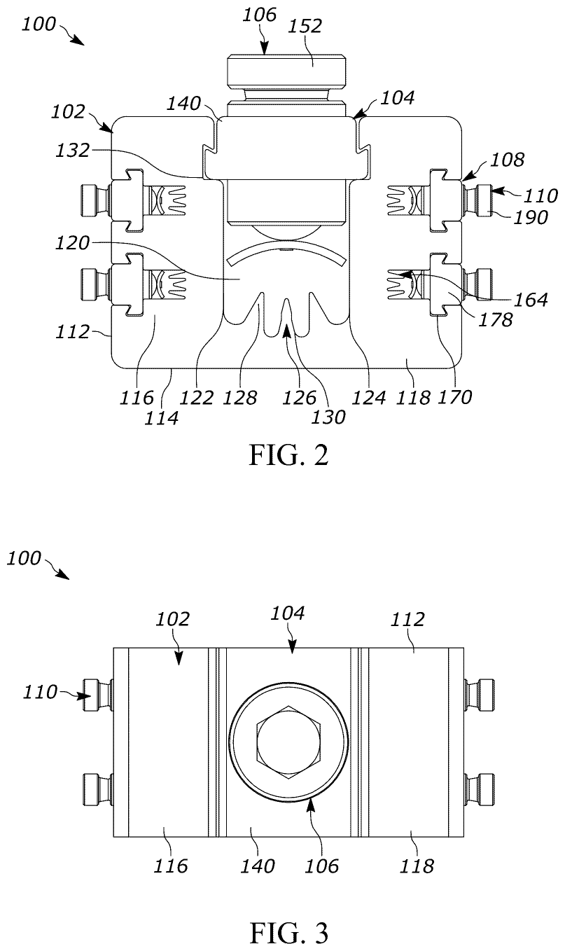

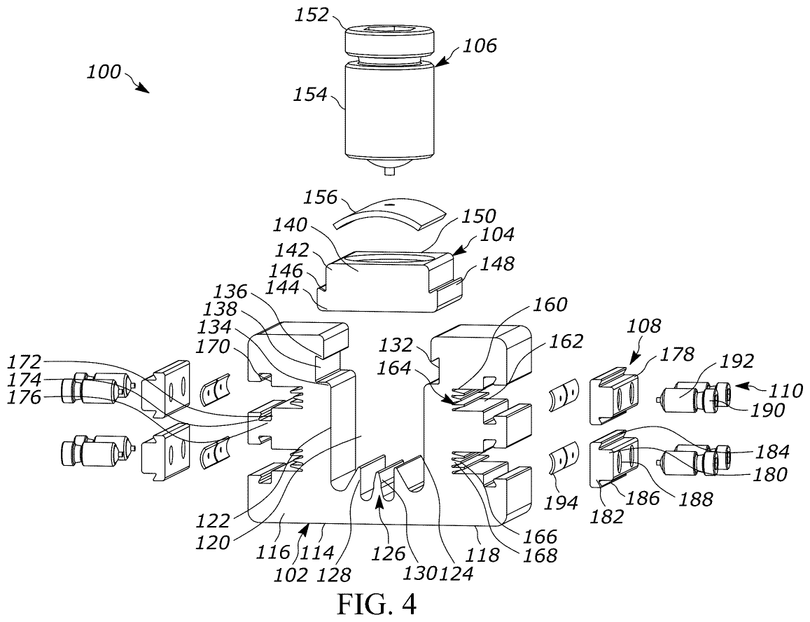

FIGS. 1-4, show an exemplary configuration of a multi-tap connector 100 having a conductor block 102, a run line cap 104, a run line bolt 106, a plurality of tap line caps 108, and a plurality of tap line bolts 110. The illustrated configuration shows a single run line cap 104 and bolt 106 and four tap line caps 108 each with two tap line bolts 110. Other configurations can utilize more or fewer run and tap lines as desired.

The conductor block 102 includes a body 112 having a substantially U-shaped configuration. The body 112 has a bottom portion 114, a first side portion 116, and a second side portion 118. A run line opening 120 is formed in the body 112 between the first side portion 116 and the second side portion 118. The run line opening 120 is configured to receive a run conductor. The size of the run line opening 120 can vary depending on the size or sizes of conductors that are to be received.

The run line opening 120 is bound on a first side by a first side wall 122 and on a second side by a second side wall 124. A set of run insulation piercing members 126 extend into the run line opening 120. The insulation piercing members 126 can be teeth, tines, or other features configured to pierce the insulating jacket of a conductor. In certain configurations, the insulation piercing members 126 include a pair of outer teeth 128 and a central tooth 130. The outer teeth 128 can extend higher than the central tooth 130 and can be angled toward the central tooth 130.

Each of the teeth 128, 130 can include an insulation piercing tip that is configured and dimensioned to pierce or cut through the insulating jacket of the run conductor to create an electrical path between the run conductor and the conductor block 102. The one or more insulation piercing members 126 can be integrally or monolithically formed into the bottom portion 114 of the conductor block 102 such that the one or more insulation piercing members 126 extend into the run opening 120.

In other configurations, the one or more insulation piercing members 126 can be attachable to the body 112 of the conductor block 102. For example, the insulation piercing members 126 can be formed as part of a removable assembly that can be mounted or secured to the body 112 of the conductor block 102. Further, the insulation piercing members 126 can be made from a different material than the body 112.

In certain implementations, performance of the insulation piercing members 126 can be improved by using a relatively harder material. The one or more insulation piercing members 126 can be made from a different material (e.g., copper, tempered aluminum, stainless steel, etc.) and secured to or attached to the conductor block 102 so that the one or more insulation piercing members 126 extend into the run opening 120.

The insulation piercing members 126 are shown having a substantially triangular configuration. However, the insulation piercing members 126 can include different shapes and sizes configured and dimensioned to pierce or cut through the insulating jacket surrounding electrical wires of the run conductor, such as one or more cone-shaped members and/or one or more members with pointed tips. Further, one or more of the insulation piercing members 126 can include serrations on one or both sides of the insulation piercing members 126.

In certain configurations, a pair of run guide slots 132 extend from the run line opening 120. The run guide slots 132 are configured to slidably receive the run line cap 104. In the illustrated configuration, the guide slots 132 include an inner wall 134, an outer wall 136, and a side wall 138. The inner wall 134 extends further into the run opening 120 than the outer wall 136. The outer wall 136 has an angled portion, forming a dovetail slot for receiving the run line cap 104 in the proper orientation.

Other configurations can utilize different sizes and shapes of guide slots, including squared and rounded configurations. Certain configurations can also utilize a unitary body where the run cap 104 is integrally formed with the conductor block.

The run line cap 104 can include a body 140 configured to mate with the run guide slots 132 and fit into the conductor block 102. In the illustrated configuration, the run line cap 104 includes an outer portion 142 and an inner portion 144. The inner portion 144 is wider than the outer portion 142 to form a first shoulder 146 and a second shoulder 148. An outer edge of the shoulders 146, 148 is angled to correspond with the angled outer wall 136 of the run guide slots 132.

The run line cap 104 slidably engages the conductor block 102 over the run line opening 120. A run bolt opening 150 is provided in the run line cap 104 to receive the run line bolt 106. The opening 150 can be threaded and sized to accommodate the bolt appropriate for the run conductor.

In certain configurations the run line bolt 106 is a shear bolt having a shearable head 152, a shank 154, and a pressure bar 156. The shank can include a thread and be threadably connected to the run line cap. The pressure bar 156 can be rotatably connected to the shank 154 and configured to engage the run conductor. In other configurations, the run line bolt 106 is a non-shear bolt.

The head 152 can be connected to the shank 154 by a shearable connection. The shearable section can be a weakened area designed to break or otherwise separate once a certain torque limit is reached. The shearable section can be formed by a frangible connection such as holes or slots placed in the material or can be formed from one or more section of reduced thickness. As the fastener is rotated, the shank 154 or an associated pressure bar 156 will engage a conductor. As the fastener is tightened, the engagement with the conductor will increase the amount of torque required to further turn the fastener. Once the torque limit is reached, the head 152 will shear, separating from the shank 154. This ensures a certain connection engagement is achieved with the conductor, while also preventing overtightening that could damage the conductor. Different shear limits can be used according to different conductors.

Similar to the run line connection, the conductor block 102 can include multiple tap openings for allowing connections to be formed with tap conductors. In certain configurations, the first side portion 116 and the second side portion 118 of the conductor block 102 each include two sets of tap line openings 158. The tap line openings 158 are bound on a first side by a first side wall 160 and on a second side by a second side wall 162. A set of tap insulation piercing members 164 extend into each of the tap line openings 158. The insulation piercing members 164 can be teeth, tines, or other features configured to pierce the insulating jacket of a conductor. In certain configurations, the insulation piercing members 164 include a pair of outer teeth 166 and a central tooth 168. The outer teeth 166 can extend farther than the central tooth 168 and can be angled toward the central tooth 168. The tap insulation piercing members 164 can have any of the same properties as the run insulation piercing members 126 described herein, including being made from different materials, having different configurations, and being formed as a separate assembly releasably connected to the conductor block 102.

A pair of tap guide slots 170 extend from each of the tap line openings 158. The tap guide slots 170 can have a similar configuration as the run guide slots 132. The tap guide slots 170 include an inner wall 172, an outer wall 174, and a side wall 176. The inner wall 172 extends further into the tap opening 158 than the outer wall 174. The outer wall 174 has an angled portion, forming a dovetail slot for receiving the tap line cap 108 in the proper orientation.

Other configurations can utilize different sizes and shapes of tap guide slots 170, including squared and rounded configurations. Fewer or more tap guide slots 170 can also be incorporated into the conductor block 102. Certain configurations can also utilize a unitary body where the tap line caps 108 are integrally formed with the conductor block 102.

The tap line caps 108 can include a body 178 configured to mate with the tap guide slots 170 and fit into the conductor block 102. In the illustrated configuration, the tap line caps 108 include an outer portion 180 and an inner portion 182. The inner portion 182 is wider than the outer portion 180 to form a first shoulder 184 and a second shoulder 186. An outer edge of the shoulders 184, 186 is angled to correspond with the angled outer wall 174 of the tap guide slots 170. The tap line caps 108 slidably engages the conductor block 102 over the tap line openings 158.

In the illustrated configuration, two bolt openings 188 are provided in each of the tap line caps 108 to receive a pair of tap line bolts 110. The openings 188 can be threaded and sized to accommodate the bolt appropriate for the tap conductor. Fewer or more tap bolt openings 188 can be used as needed. The use of two tap bolt openings 188 can allow each tap line opening 158 to receive two tap lines, one from each side. Certain configurations can utilize an internal divider, as part of the conductor block 102 or tap line caps 108, as needed, to separate each tap line opening 158 into a first and second chamber. This can help a user ensure proper seating of the tap line conductors.

Each tap line bolt 110 can include a head 190, a shank 192, and a pressure bar 194. The shank 192 can include a thread and be threadably connected to the tap line cap 108. The pressure bar 194 can be rotatably connected to the shank 192 and configured to engage the run conductor. The head 190 can be connected to the shank 192 by a shearable connection as discussed with respect to the run line shear bolt 106. In other configurations, the head is a non-shear bolt.

During installation, a tap conductor can be placed into a tap opening 158. The associated tap bolt 110 is then tightened by rotating the head 190 so that the tap pressure bar 194 engages the tap conductor. The tap bolt 110 is then tightened further so that the tap conductor is driven into the tap insulation piercing members 164. The insulation piercing members 164 will pierce the outer insulation of the tap conductor to form an electrical and mechanical connection with the tap conductor and the conductor block 102. At a certain point, the shear limit of the head 190 will be reached, resulting in the head 190 separating from the shank 192 and preventing overtightening. Additional tap conductors can be connected in this manner as needed. Similarly, the run conductor can be placed in the run line opening 120. The run bolt 106 is then tightened by rotating the head 152 so that the tap pressure bar 156 engages the run conductor. The run bolt 106 is then tightened further so that the run conductor is driven into the run insulation piercing members 126. The insulation piercing members 126 will pierce the outer insulation of the tap conductor to form an electrical and mechanical connection with the tap conductor and the conductor block 102. At a certain point, the shear limit of the head 152 will be reached, resulting in the head 152 separating from the shank 154 and preventing overtightening. The run and tap conductors can be connected to the conductor block 102 in this manner in any order.

The use of the shear bolts 106, 110 and the insulation piercing members 126, 164 simplifies the installation procedure and can result in a faster more repeatable connection. For example, the need to strip conductors before connection to the conductor block 102 can be eliminated and lighter tools, such as an impact driver, can be used instead of heavier crimping tools. However, advantages of easier and more reliable connections are also achieved without the use of shear bolts.

In some configurations, the conductor block 102 and body 112 can be modified to connect to other conductor blocks or block extensions to increase the number of tap lines that can be connected to the block 102. For example, the body 112 can include mating features, such as male and female mating features that can allow other blocks or extensions to be added on in the field as needed. These could be connected to the bottom of the block to add additional tap openings 158 to connect off of the existing run opening 120.

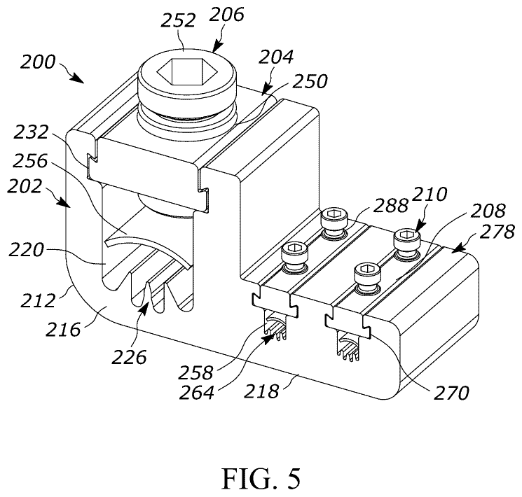

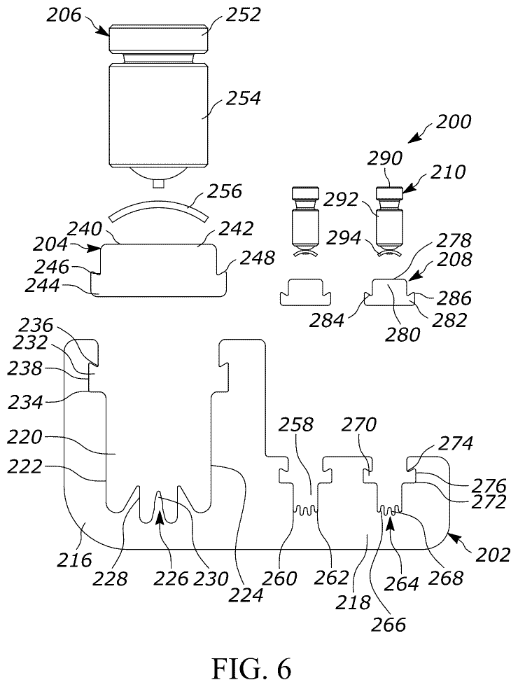

FIGS. 5 and 6, show an exemplary configuration of a multi-tap connector 200 having a conductor block 202, a run line cap 204, a run line bolt 206, a plurality of tap line caps 208, and a plurality of tap line bolts 210. The illustrated configuration shows a single run line cap 204 and bolt 206 and two tap line caps 208 each with two tap line bolts 210. Other configurations can utilize more or fewer run and tap lines as desired.

The conductor block 202 includes a body 212 having a substantially L-shaped configuration. The body 212 has a run side portion 216 and a tap side portion 218. A run line opening 220 is formed in run side portion 216. The run line opening 220 is configured to receive a run conductor. The size of the run line opening 220 can vary depending on the size or sizes of conductors that are to be received.

The run line opening 220 is bound on a first side by a first side wall 222 and on a second side by a second side wall 224. A set of run insulation piercing members 226 extend into the run line opening 220. The insulation piercing members 226 can be teeth, tines, or other features configured to pierce the insulating jacket of a conductor. In certain configurations, the insulation piercing members 226 include a pair of outer teeth 228 and a central tooth 230. The outer teeth 228 can extend higher than the central tooth 230 and can be angled toward the central tooth 230.

Each of the teeth 228, 230 can include an insulation piercing tip that is configured and dimensioned to pierce or cut through the insulating jacket of the run conductor to create an electrical path between the run conductor and the conductor block 202. The one or more insulation piercing members 226 can be integrally or monolithically formed into the bottom portion 214 of the conductor block 202 such that the one or more insulation piercing members 226 extend into the run opening 220. In other configurations, the one or more insulation piercing members 226 can be attachable to the body 212 of the conductor block 202.

For example, the insulation piercing members 226 can be formed as part of a removable assembly that can be mounted or secured to the body 212 of the conductor block 202. Further, the insulation piercing members 226 can be made from a different material than the body 212.

In certain configurations, a pair of run guide slots 232 extend from the run line opening 220. The run guide slots 232 are configured to slidably receive the run line cap 204. In the illustrated configuration, the guide slots 232 include an inner wall 234, an outer wall 236, and a side wall 238. The inner wall 234 extends further into the run opening 220 than the outer wall 236. The outer wall 236 has an angled portion, forming a dovetail slot for receiving the run line cap 204 in the proper orientation.

Other configurations can utilize different sizes and shapes of guide slots, including squared and rounded configurations. Certain configurations can also utilize a unitary body where the run cap 204 is integrally formed with the conductor block.

The run line cap 204 can include a body 240 configured to mate with the run guide slots 232 and fit into the conductor block 202. In the illustrated configuration, the run line cap 204 includes an outer portion 242 and an inner portion 244. The inner portion 244 is wider than the outer portion 242 to form a first shoulder 246 and a second shoulder 248. An outer edge of the shoulders 246, 248 is angled to correspond with the angled outer wall 236 of the run guide slots 232.

The run line cap 204 slidably engages the conductor block 202 over the run line opening 220. A run bolt opening 250 is provided in the run line cap 204 to receive the run line bolt 206. The opening 250 can be threaded and sized to accommodate the bolt appropriate for the run conductor.

In certain configurations the run line bolt 206 is a shear bolt having a shearable head 252, a shank 254, and a pressure bar 256. The shank can include a thread and be threadably connected to the run line cap 204. The pressure bar 256 can be rotatably connected to the shank 254 and configured to engage the run conductor. In other configurations, the run line bolt 206 is a non-shear bolt.

The head 252 can be connected to the shank 254 by a shearable connection having a torque limit. As the fastener is rotated, the shank 254 or an associated pressure bar 256 will engage a conductor. As the fastener is tightened, the engagement with the conductor will increase the amount of torque required to further turn the fastener. Once the torque limit is reached, the head 252 will shear, separating from the shank 254. This ensures a certain connection engagement is achieved with the conductor, while also preventing overtightening that could damage the conductor. Different shear limits can be used according to different conductors.

Similar to the run line connection, the conductor block 202 can include multiple tap openings for allowing connections to be formed with tap conductors. In certain configurations, the tap side portion 228 of the conductor block 202 includes two sets of tap line openings 258. The tap line openings 258 are bound on a first side by a first side wall 260 and on a second side by a second side wall 262. A set of tap insulation piercing members 264, extend into each of the tap line openings 258. The insulation piercing members 264 can be teeth, tines, or other features configured to pierce the insulating jacket of a conductor. In certain configurations, the insulation piercing members 264 include a pair of outer teeth 266 and a central tooth 268. The outer teeth 266 can extend farther than the central tooth 268 and can be angled toward the central tooth 268. The tap insulation piercing members 264 can have any of the same properties as the run insulation piercing members 226 described herein, including being made from different materials, having different configurations, and being formed as a separate assembly releasably connected to the conductor block 202.

A pair of tap guide slots 270 extend from each of the tap line openings 258. The tap guide slots 270 can have a similar configuration as the run guide slots 232. The tap guide slots 270 include an inner wall 272, an outer wall 274, and a side wall 276. The inner wall 272 extends further into the tap opening 258 than the outer wall 274. The outer wall 274 has an angled portion, forming a dovetail slot for receiving the tap line cap 208 in the proper orientation.

Other configurations can utilize different sizes and shapes of tap guide slots 270, including squared and rounded configurations. Fewer or more tap guide slots 270 can also be incorporated into the conductor block 202. Certain configurations can also utilize a unitary body where the tap line caps 208 are integrally formed with the conductor block 202.

The tap line caps 208 can include a body 278 configured to mate with the tap guide slots 270 and fit into the conductor block 202. In the illustrated configuration, the tap line caps 208 include an outer portion 280 and an inner portion 282. The inner portion 282 is wider than the outer portion 280 to form a first shoulder 284 and a second shoulder 286. An outer edge of the shoulders 284, 286 is angled to correspond with the angled outer wall 274 of the tap guide slots 270. The tap line caps 208 slidably engages the conductor block 202 over the tap line openings 258.

In the illustrated configuration, two bolt openings 288 are provided in each of the tap line caps 208 to receive a pair of tap line bolts 210. The openings 288 can be threaded and sized to accommodate the bolt appropriate for the tap conductor. Fewer or more tap bolt openings 288 can be used as needed. The use of two tap bolt openings 288 can allow each tap line opening 258 to receive two tap lines, one from each side. Certain configurations can utilize an internal divider, as part of the conductor block 202 or tap line caps 208, as needed, to separate each tap line opening 258 into a first and second chamber. This can help a user ensure proper seating of the tap line conductors.

Each tap line bolt 210 can include a head 290, a shank 292, and a pressure bar 294. The shank 292 can include a thread and be threadably connected to the tap line cap 208. The pressure bar 294 can be rotatably connected to the shank 292 and configured to engage the run conductor. The head 290 can be connected to the shank 292 by a shearable connection as discussed with respect to the run line shear bolt 206. In other configurations, the head 290 is a non-shear bolt.

In some configurations, the conductor block 202 body 212 can be modified to connect to other conductor blocks or block extensions to increase the number of tap lines that can be connected to the block 202. For example, the body 212 can include mating features, such as male and female mating features that can allow other blocks or extensions to be added on in the field as needed. These could be connected to the tap side portion 218 of the block to add additional tap openings 258 to connect off of the existing run opening 220. The tap side portion 218 can also be formed to include additional tap line openings 258 as required.

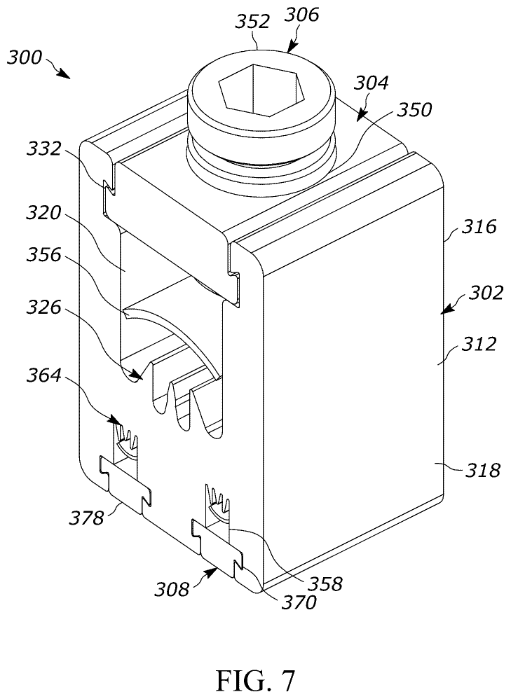

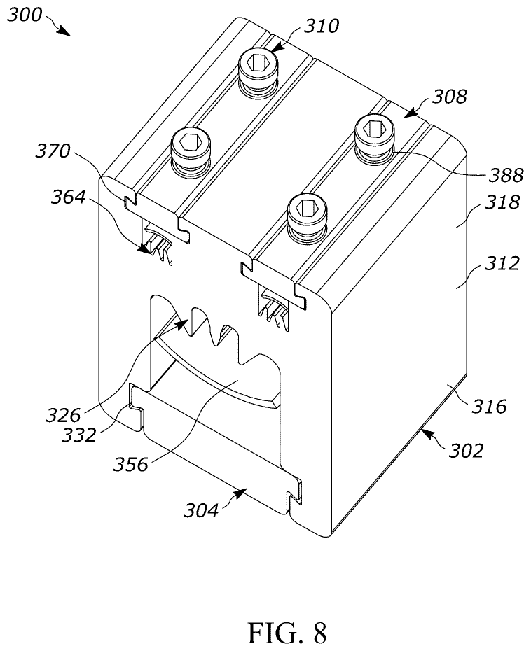

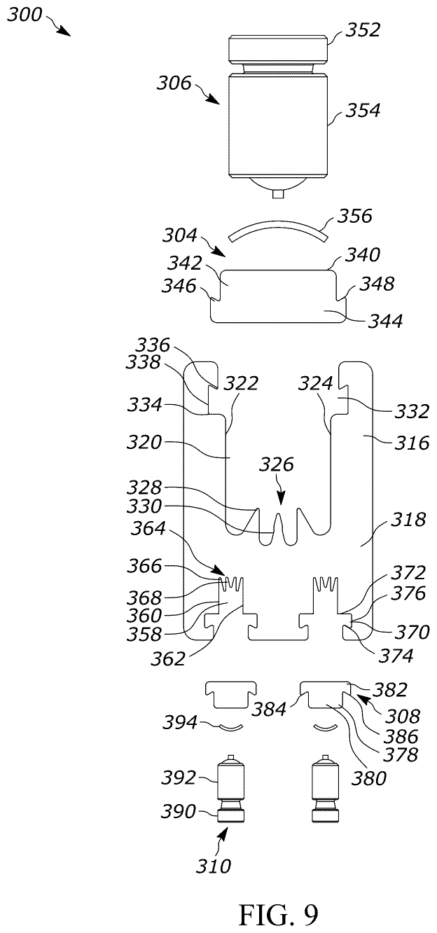

FIGS. 7-9, show an exemplary configuration of a multi-tap connector 300 having a conductor block 302, a run line cap 304, a run line bolt 306, a plurality of tap line caps 308, and a plurality of tap line bolts 310. The illustrated configuration shows a single run line cap 304 and bolt 306 and two tap line caps 308 each with two tap line bolts 310. Other configurations can utilize more or fewer run and tap lines as desired.

The conductor block 302 includes a body 312 having a run side portion 316 and a tap side portion 318. A run line opening 320 is formed in the run side portion 316. The run line opening 320 is configured to receive a run conductor. The size of the run line opening 320 can vary depending on the size or sizes of conductors that are to be received.

The run line opening 320 is bound on a first side by a first side wall 322 and on a second side by a second side wall 324. A set of run insulation piercing members 326 extend into the run line opening 320. The insulation piercing members 326 can be teeth, tines, or other features configured to pierce the insulating jacket of a conductor. In certain configurations, the insulation piercing members 326 include a pair of outer teeth 328 and a central tooth 330. The outer teeth 328 can extend higher than the central tooth 330 and can be angled toward the central tooth 330.

Each of the teeth 328, 330 can include an insulation piercing tip that is configured and dimensioned to pierce or cut through the insulating jacket of the run conductor to create an electrical path between the run conductor and the conductor block 302. The one or more insulation piercing members 326 can be integrally or monolithically formed into the conductor block 302 such that the one or more insulation piercing members 326 extend into the run opening 320. In other configurations, the one or more insulation piercing members 326 can be attachable to the body 312 of the conductor block 302.

For example, the insulation piercing members 326 can be formed as part of a removable assembly that can be mounted or secured to the body 312 of the conductor block 302. Further, the insulation piercing members 326 can be made from a different material than the body 312.

In certain configurations, a pair of run guide slots 332 extend from the run line opening 320. The run guide slots 332 are configured to slidably receive the run line cap 304. In the illustrated configuration, the guide slots 332 include an inner wall 334, an outer wall 336, and a side wall 338. The inner wall 334 extends further into the run opening 220 than the outer wall 336. The outer wall 336 has an angled portion, forming a dovetail slot for receiving the run line cap 304 in the proper orientation.

Other configurations can utilize different sizes and shapes of guide slots, including squared and rounded configurations. Certain configurations can also utilize a unitary body where the run cap 304 is integrally formed with the conductor block.

The run line cap 304 can include a body 340 configured to mate with the run guide slots 332 and fit into the conductor block 302. In the illustrated configuration, the run line cap 304 includes an outer portion 342 and an inner portion 344. The inner portion 344 is wider than the outer portion 342 to form a first shoulder 346 and a second shoulder 348. An outer edge of the shoulders 346, 348 is angled to correspond with the angled outer wall 336 of the run guide slots 332.

The run line cap 304 slidably engages the conductor block 302 over the run line opening 320. A run bolt opening 350 is provided in the run line cap 304 to receive the run line bolt 306. The opening 350 can be threaded and sized to accommodate the bolt appropriate for the run conductor.

In certain configurations the run line bolt 306 is a shear bolt having a shearable head 352, a shank 354, and a pressure bar 356. The shank can include a thread and be threadably connected to the run line cap 304. The pressure bar 356 can be rotatably connected to the shank 354 and configured to engage the run conductor. In other configurations, the run line bolt 306 is a non-shear bolt.

The head 352 can be connected to the shank 354 by a shearable connection having a torque limit. As the fastener is rotated, the shank 354 or an associated pressure bar 356 will engage a conductor. As the fastener is tightened, the engagement with the conductor will increase the amount of torque required to further turn the fastener. Once the torque limit is reached, the head 352 will shear, separating from the shank 354. This ensures a certain connection engagement is achieved with the conductor, while also preventing overtightening that could damage the conductor. Different shear limits can be used according to different conductors.

Similar to the run line connection, the conductor block 302 can include multiple tap openings for allowing connections to be formed with tap conductors. In certain configurations, the tap side portion 328 of the conductor block 302 each include two sets of tap line openings 358. The tap line openings 358 are bound on a first side by a first side wall 360 and on a second side by a second side wall 362. A set of tap insulation piercing members 364, extend into each of the tap line openings 358. The insulation piercing members 364 can be teeth, tines, or other features configured to pierce the insulating jacket of a conductor. In certain configurations, the insulation piercing members 364 include a pair of outer teeth 366 and a central tooth 368. The outer teeth 366 can extend farther than the central tooth 368 and can be angled toward the central tooth 368. The tap insulation piercing members 364 can have any of the same properties as the run insulation piercing members 326 described herein, including being made from different materials, having different configurations, and being formed as a separate assembly releasably connected to the conductor block 302.

A pair of tap guide slots 370 extend from each of the tap line openings 358. The tap guide slots 370 can have a similar configuration as the run guide slots 332. The tap guide slots 370 include an inner wall 372, an outer wall 374, and a side wall 376. The inner wall 372 extends further into the tap opening 358 than the outer wall 374. The outer wall 374 has an angled portion, forming a dovetail slot for receiving the tap line cap 308 in the proper orientation.

Other configurations can utilize different sizes and shapes of tap guide slots 370, including squared and rounded configurations. Fewer or more tap guide slots 370 can also be incorporated into the conductor block 302. Certain configurations can also utilize a unitary body where the tap line caps 308 are integrally formed with the conductor block 302.

The tap line caps 308 can include a body 378 configured to mate with the tap guide slots 370 and fit into the conductor block 302. In the illustrated configuration, the tap line caps 308 include an outer portion 380 and an inner portion 382. The inner portion 382 is wider than the outer portion 380 to form a first shoulder 384 and a second shoulder 386. An outer edge of the shoulders 384, 386 is angled to correspond with the angled outer wall 374 of the tap guide slots 370. The tap line caps 308 slidably engages the conductor block 302 over the tap line openings 358.

In the illustrated configuration, two bolt openings 388 are provided in each of the tap line caps 308 to receive a pair of tap line bolts 310. The openings 388 can be threaded and sized to accommodate the bolt appropriate for the tap conductor. Fewer or more tap bolt openings 388 can be used as needed. The use of two tap bolt openings 388 can allow each tap line opening 358 to receive two tap lines, one from each side. Certain configurations can utilize an internal divider, as part of the conductor block 302 or tap line caps 308, as needed, to separate each tap line opening 358 into a first and second chamber. This can help a user ensure proper seating of the tap line conductors.

Each tap line bolt 310 can include a head 390, a shank 392, and a pressure bar 394. The shank 392 can include a thread and be threadably connected to the tap line cap 308. The pressure bar 394 can be rotatably connected to the shank 392 and configured to engage the run conductor. The head 390 can be connected to the shank 392 by a shearable connection as discussed with respect to the run line shear bolt 306. In other configurations, the head 390 is a non-shear bolt.

In some configurations, the conductor block 302 body 312 can be modified to connect to other conductor blocks or block extensions to increase the number of tap lines that can be connected to the block 302. For example, the body 312 can include mating features, such as male and female mating features that can allow other blocks or extensions to be added on in the field as needed. These could be connected to the tap sides of the block 302 to add additional tap openings 358 to connect off of the existing run opening 320.

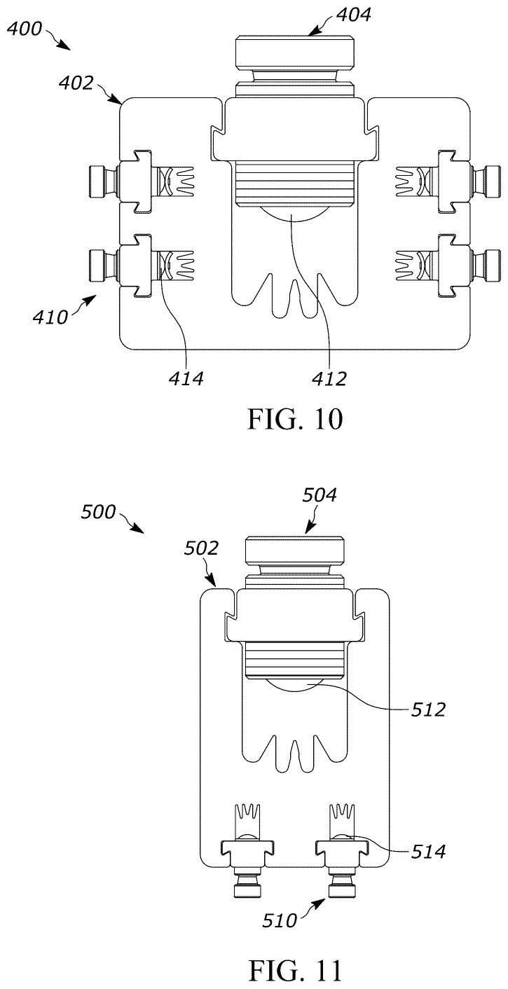

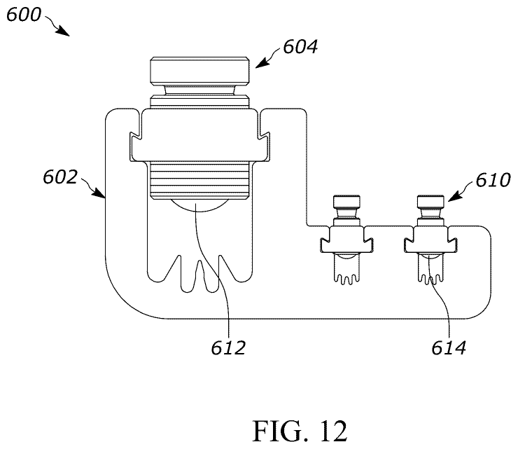

FIGS. 10-12 show alternative embodiments of the conductor blocks 102, 202, 302 having run bolts and tap bolts without pressure bars. FIG. 10 shows a connector 400 having a conductor block 402 and a run bolt 404 and a set of tap bolts 410. The run bolt 404 has a convex end 412 for engaging the run conductor and the tap bolts 410 have a convex end 414 for engaging the tap conductors. FIG. 11 shows a connector 500 having a conductor block 502 and a run bolt 504 and a set of tap bolts 510. The run bolt 504 has a convex end 512 for engaging the run conductor and the tap bolts 510 have a convex end 514 for engaging the tap conductors. FIG. 12 shows a connector 600 having a conductor block 602 and a run bolt 604 and a set of tap bolts 610. The run bolt 604 has a convex end 612 for engaging the run conductor and the tap bolts 610 have a convex end 614 for engaging the tap conductors.

Although the exemplary configurations described utilize a shear bolt with a single head, different kinds of shear bolts can be used. For example, shear bolts having more than one head can be used to set different shear limits or to provide a non-shear head to allow for easier removal of the fastener after the initial head is sheared. Different pressure bars, pressure discs, and no pressure bar configurations can also be used. Further configurations can implement insulation piercing as part of the fastener instead of, or in addition to, the insulation piercing members associated with the conductor blocks. Other embodiments can utilize non-shear bolts, with torque limits eliminated or set by other ways on the fastener or as part of the installation tool.

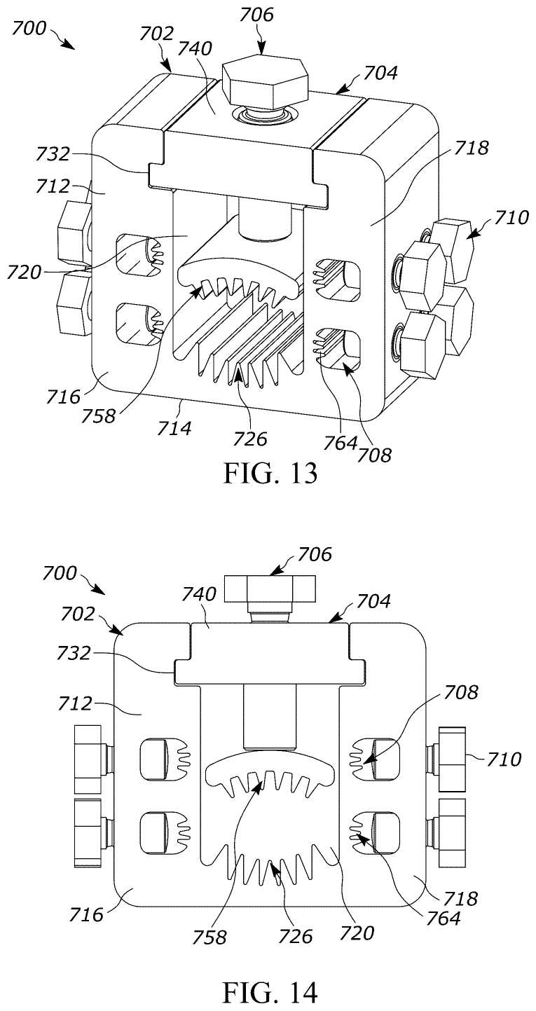

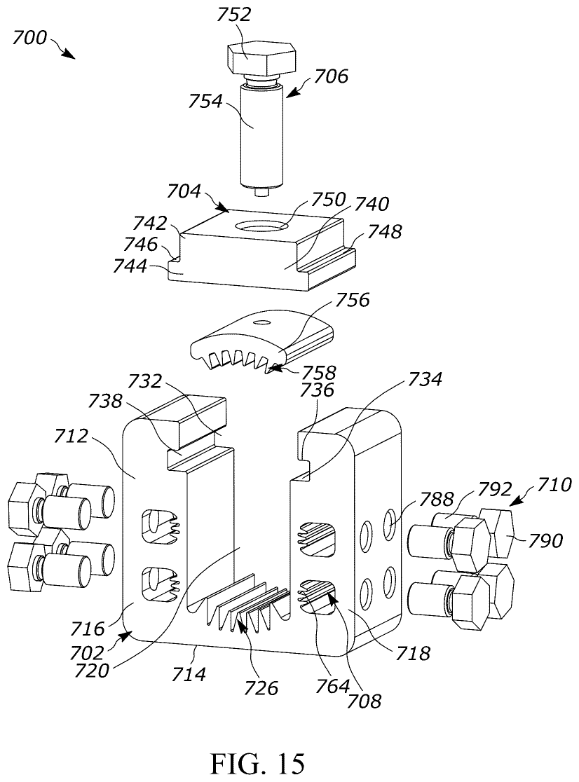

FIGS. 13-15, show an exemplary configuration of a multi-tap connector 700 having a conductor block 702, a run line cap 704, a run line bolt 706, a plurality of run line openings 708 extending into the conductor block 702, and a plurality of tap line bolts 710. The illustrated configuration shows a single run line cap 704 and bolt 706 and four tap line openings 708 each with two tap line bolts 710. Other configurations can utilize more or fewer run and tap lines as desired.

The conductor block 702 includes a body 712 having a substantially U-shaped configuration. The body 712 has a bottom portion 714, a first side portion 716, and a second side portion 718. A run line opening 720 is formed in the body 712 between the first side portion 716 and the second side portion 718. The run line opening 720 is configured to receive a run conductor. The size of the run line opening 720 can vary depending on the size or sizes of conductors that are to be received.

The run line opening 720 is bound on a first side by a first side wall and on a second side by a second side wall. A set of run insulation piercing members 726 extend into the run line opening 720. The insulation piercing members 726 can be teeth, tines, or other features configured to pierce the insulating jacket of a conductor. In certain configurations, the insulation piercing members 726 include a plurality of teeth extending in an arc.

Each of the teeth can include an insulation piercing tip that is configured and dimensioned to pierce or cut through the insulating jacket of the run conductor to create an electrical path between the run conductor and the conductor block 702. The one or more insulation piercing members 726 can be integrally or monolithically formed into the bottom portion 714 of the conductor block 702 such that the one or more insulation piercing members 726 extend into the run opening 720.

In other configurations, the one or more insulation piercing members 726 can be attachable to the body 712 of the conductor block 702. For example, the insulation piercing members 726 can be formed as part of a removable assembly that can be mounted or secured to the body 712 of the conductor block 702. Further, the insulation piercing members 726 can be made from a different material than the body 712.

In certain implementations, performance of the insulation piercing members 726 can be improved by using a relatively harder material. The one or more insulation piercing members 726 can be made from a different material (e.g., copper, tempered aluminum, stainless steel, etc.) and secured to or attached to the conductor block 702 so that the one or more insulation piercing members 726 extend into the run opening 720.

The insulation piercing members 726 are shown having a substantially triangular configuration. However, the insulation piercing members 726 can include different shapes and sizes configured and dimensioned to pierce or cut through the insulating jacket surrounding electrical wires of the run conductor, such as one or more cone-shaped members and/or one or more members with pointed tips. Further, one or more of the insulation piercing members 726 can include serrations on one or both sides of the insulation piercing members 726.

In certain configurations, a pair of run guide slots 732 extend from the run line opening 720. The run guide slots 732 are configured to slidably receive the run line cap 704. In the illustrated configuration, the guide slots 732 include an inner wall 734, an outer wall 736, and a side wall 738. The inner wall 734 extends further into the run opening 720 than the outer wall 736.

Other configurations can utilize different sizes and shapes of guide slots, including squared and rounded configurations. Certain configurations can also utilize a unitary body where the run cap 704 is integrally formed with the conductor block.

The run line cap 704 can include a body 740 configured to mate with the run guide slots 732 and fit into the conductor block 702. In the illustrated configuration, the run line cap 704 includes an outer portion 742 and an inner portion 744. The inner portion 744 is wider than the outer portion 742 to form a first shoulder 746 and a second shoulder 748. The shoulders 746, 748 correspond with the run guide slots 732.

The run line cap 704 slidably engages the conductor block 702 over the run line opening 720. A run bolt opening 750 is provided in the run line cap 704 to receive the run line bolt 706. The opening 750 can be threaded and sized to accommodate the bolt appropriate for the run conductor.

In certain configurations the run line bolt 706 is a shear bolt having a shearable head 752, a shank 754, and a pressure bar 756. The shank can include a thread and be threadably connected to the run line cap. The pressure bar 756 can be rotatably connected to the shank 754 and configured to engage the run conductor. In other configurations, the run line bolt 706 is a non-shear bolt.

In certain configurations, the pressure bar 756 can include a set of insulation piercing members 758 that extend from the pressure bar 756 toward the insulation piercing members 726 of the run line opening 720. In the illustrated configuration, the pressure bar insulation piercing members 758 include a plurality of teeth extending in an arc. Other configurations can also be used.

The conductor block 702 can include multiple tap openings 708 for allowing connections to be formed with tap conductors. In certain configurations, the first side portion 716 and the second side portion 718 of the conductor block 702 each include two sets of tap line openings 708. A set of tap insulation piercing members 764, extend into each of the tap line openings 708. The insulation piercing members 764 can be teeth, tines, or other features configured to pierce the insulating jacket of a conductor.

In the illustrated configuration, two bolt openings 788 are provided in communication with each of the tap line openings 708 to receive a pair of tap line bolts 710. The bolt openings 788 can be threaded and sized to accommodate the bolt appropriate for the tap conductor. Fewer or more tap bolt openings 788 can be used as needed. The use of two tap bolt openings 788 can allow each tap line opening 708 to receive two tap lines, one from each side. Certain configurations can utilize an internal divider, as part of the conductor block 702, as needed, to separate each tap line opening 708 into a first and second chamber. This can help a user ensure proper seating of the tap line conductors.

Each tap line bolt 710 can include a head 790 and a shank 792. The shank 792 can include a thread and be threadably connected to the bolt opening 788. The head 790 can be connected to the shank 792 by a shearable connection as discussed with respect to the run line shear bolt 706. In other configurations, the head 790 is a non-shear bolt.

In some configurations, the conductor block 702 body 712 can be modified to connect to other conductor blocks or block extensions to increase the number of tap lines that can be connected to the block 702. For example, the body 712 can include mating features, such as male and female mating features that can allow other blocks or extensions to be added on in the field as needed. These could be connected to the bottom of the block to add additional tap openings 708 to connect off of the existing run opening 720.

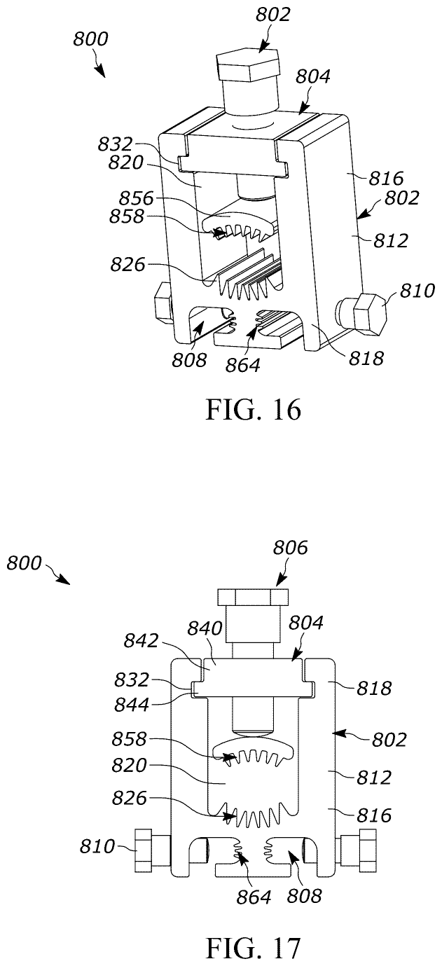

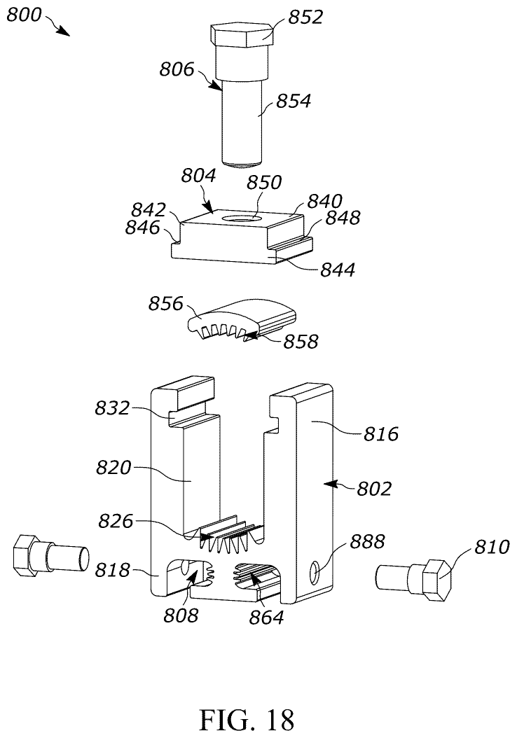

FIGS. 16-18, show an exemplary configuration of a multi-tap connector 800 having a conductor block 802, a run line cap 804, a run line bolt 806, a plurality of tap line openings 808, and a plurality of tap line bolts 810. The illustrated configuration shows a single run line cap 804 and bolt 806 and two tap line openings 808 each with a single tap line bolt 810. Other configurations can utilize more or fewer run and tap lines as desired.

The conductor block 802 includes a body 812 having a run side portion 816 and a tap side portion 818. A run line opening 820 is formed in run side portion 816. The run line opening 820 is configured to receive a run conductor. The size of the run line opening 820 can vary depending on the size or sizes of conductors that are to be received.

The run line opening 820 is bound on a first side by a first side wall and on a second side by a second side wall. A set of run insulation piercing members 826 extend into the run line opening 820. The insulation piercing members 826 can be teeth, tines, or other features configured to pierce the insulating jacket of a conductor. In certain configurations, the insulation piercing members 826 include a plurality of teeth extending in an arc.

The teeth can include an insulation piercing tip that is configured and dimensioned to pierce or cut through the insulating jacket of the run conductor to create an electrical path between the run conductor and the conductor block 802. The one or more insulation piercing members 826 can be integrally or monolithically formed into the conductor block 802 such that the one or more insulation piercing members 826 extend into the run opening 820. In other configurations, the one or more insulation piercing members 826 can be attachable to the body 812 of the conductor block 802.

For example, the insulation piercing members 826 can be formed as part of a removable assembly that can be mounted or secured to the body 812 of the conductor block 802. Further, the insulation piercing members 826 can be made from a different material than the body 812.

In certain configurations, a pair of run guide slots 832 extend from the run line opening 820. The run guide slots 832 are configured to slidably receive the run line cap 804. The run guide slots have a rectangular configuration with an inner wall extending further than an outer wall. Other configurations can utilize different sizes and shapes of guide slots, including squared and rounded configurations. Certain configurations can also utilize a unitary body where the run cap 804 is integrally formed with the conductor block.

The run line cap 804 can include a body 840 configured to mate with the run guide slots 832 and fit into the conductor block 802. In the illustrated configuration, the run line cap 804 includes an outer portion 842 and an inner portion 844. The inner portion 844 is wider than the outer portion 842 to form a first shoulder 846 and a second shoulder 848. The run line cap 804 slidably engages the conductor block 802 over the run line opening 820. A run bolt opening 850 is provided in the run line cap 804 to receive the run line bolt 806. The opening 850 can be threaded and sized to accommodate the bolt appropriate for the run conductor.

In certain configurations the run line bolt 806 is a shear bolt having a shearable head 852, a shank 854, and a pressure bar 856. The shank can include a thread and be threadably connected to the run line cap 804. The pressure bar 856 can be rotatably connected to the shank 854 and configured to engage the run conductor. In other configurations, the run line bolt 806 is a non-shear bolt.

In certain configurations, the pressure bar 856 can include a set of insulation piercing members 858 that extend from the pressure bar 856 toward the insulation piercing members 826 of the run line opening 820. In the illustrated configuration, the pressure bar insulation piercing members 858 include a plurality of teeth extending in an arc. Other configurations can also be used.

The head 852 can be connected to the shank 854 by a shearable connection having a torque limit. As the fastener is rotated, the shank 854 or an associated pressure bar 856 will engage a conductor. As the fastener is tightened, the engagement with the conductor will increase the amount of torque required to further turn the fastener. Once the torque limit is reached, the head 852 will shear, separating from the shank 854. This ensures a certain connection engagement is achieved with the conductor, while also preventing overtightening that could damage the conductor. Different shear limits can be used according to different conductors. In other configurations, the head 850 is a non-shear bolt.

Similar to the run line connection, the conductor block 802 can include multiple tap openings 808 for allowing connections to be formed with tap conductors. In certain configurations, the tap side portion 828 of the conductor block 802 includes two tap line openings 808. The tap line openings 808 can be open to the exterior of the conductor block 802, as shown, or closed. A set of tap insulation piercing members 864 extend into each of the tap line openings 808. The insulation piercing members 864 can be teeth, tines, or other features configured to pierce the insulating jacket of a conductor.

In the illustrated configuration, a bolt opening 888 is provided in each of the tap line openings 808 to receive a pair of tap line bolts 810. The openings 888 can be threaded and sized to accommodate the bolt appropriate for the tap conductor. Fewer or more tap bolt openings 888 can be used as needed.

Each tap line bolt 810 can include a head 890 and a shank 892. The shank 892 can include a thread and be threadably connected to the tap line cap 808. The head 890 can be connected to the shank 892 by a shearable connection as discussed with respect to the run line shear bolt 806. In other configurations, the head 890 is a non-shear bolt.

In some configurations, the conductor block 802 body 812 can be modified to connect to other conductor blocks or block extensions to increase the number of tap lines that can be connected to the block 802. For example, the body 812 can include mating features, such as male and female mating features that can allow other blocks or extensions to be added on in the field as needed. These could be connected to the tap sides of the block 802 to add additional tap openings 808 to connect off of the existing run opening 820.

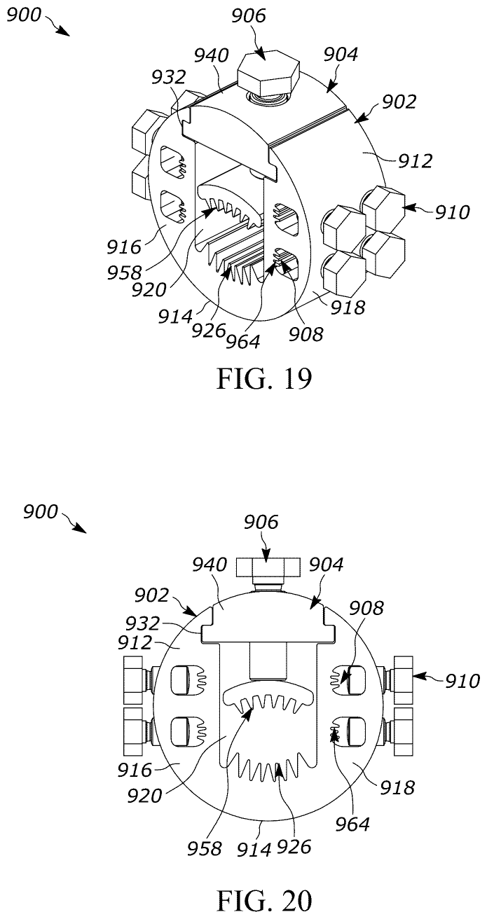

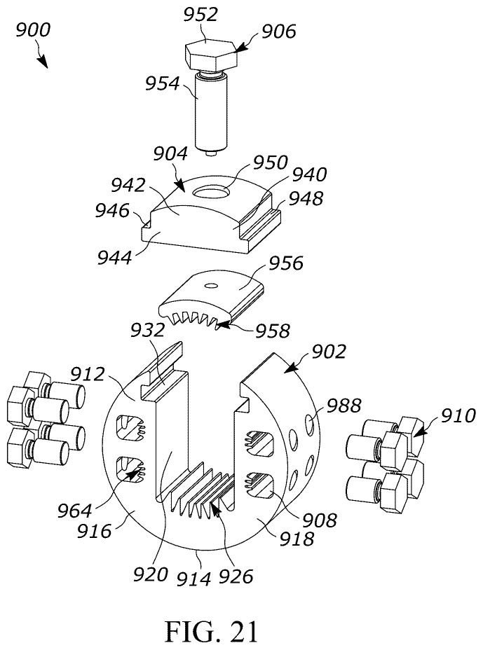

FIGS. 19-21, show an exemplary configuration of a multi-tap connector 900 having a conductor block 902, a run line cap 904, a run line bolt 906, a plurality of run line openings 908 extending into the conductor block 902, and a plurality of tap line bolts 910. The illustrated configuration shows a single run line cap 904 and bolt 906 and four tap line openings 908 each with two tap line bolts 910. Other configurations can utilize more or fewer run and tap lines as desired.

The conductor block 902 includes a body 912 having a substantially rounded U-shaped configuration with curved sides. The body 912 has a bottom portion 914, a first side portion 916, and a second side portion 918. A run line opening 920 is formed in the body 912 between the first side portion 916 and the second side portion 918. The run line opening 920 is configured to receive a run conductor. The size of the run line opening 920 can vary depending on the size or sizes of conductors that are to be received.

The run line opening 920 is bound on a first side by a first side wall and on a second side by a second side wall. A set of run insulation piercing members 926 extend into the run line opening 920. The insulation piercing members 926 can be teeth, tines, or other features configured to pierce the insulating jacket of a conductor. In certain configurations, the insulation piercing members 926 include a plurality of teeth extending in an arc.

Each of the teeth can include an insulation piercing tip that is configured and dimensioned to pierce or cut through the insulating jacket of the run conductor to create an electrical path between the run conductor and the conductor block 902. The one or more insulation piercing members 926 can be integrally or monolithically formed into the bottom portion 914 of the conductor block 902 such that the one or more insulation piercing members 926 extend into the run opening 920.

In other configurations, the one or more insulation piercing members 926 can be attachable to the body 912 of the conductor block 902. For example, the insulation piercing members 926 can be formed as part of a removable assembly that can be mounted or secured to the body 912 of the conductor block 902. Further, the insulation piercing members 926 can be made from a different material than the body 912.

In certain implementations, performance of the insulation piercing members 926 can be improved by using a relatively harder material. The one or more insulation piercing members 926 can be made from a different material (e.g., copper, tempered aluminum, stainless steel, etc.) and secured to or attached to the conductor block 902 so that the one or more insulation piercing members 926 extend into the run opening 920.

The insulation piercing members 926 are shown having a substantially triangular configuration. However, the insulation piercing members 926 can include different shapes and sizes configured and dimensioned to pierce or cut through the insulating jacket surrounding electrical wires of the run conductor, such as one or more cone-shaped members and/or one or more members with pointed tips. Further, one or more of the insulation piercing members 926 can include serrations on one or both sides of the insulation piercing members 926.

In certain configurations, a pair of run guide slots 932 extend from the run line opening 920. The run guide slots 932 are configured to slidably receive the run line cap 904. In the illustrated configuration, the guide slots 932 include an inner wall, an outer wall, and a side wall. The inner wall extends further into the run opening 920 than the outer wall.

Other configurations can utilize different sizes and shapes of guide slots, including squared and rounded configurations. Certain configurations can also utilize a unitary body where the run cap 904 is integrally formed with the conductor block.

The run line cap 904 can include a body 940 configured to mate with the run guide slots 932 and fit into the conductor block 902. In the illustrated configuration, the run line cap 904 includes an outer portion 942 and an inner portion 944. The outer portion 942 can have a curved upper edge corresponding to the curved sides of the conductor block body 912. The inner portion 944 is wider than the outer portion 942 to form a first shoulder 946 and a second shoulder 948. The shoulders 946, 948 correspond with the run guide slots 932.

The run line cap 904 slidably engages the conductor block 902 over the run line opening 920. A run bolt opening 950 is provided in the run line cap 904 to receive the run line bolt 906. The opening 950 can be threaded and sized to accommodate the bolt appropriate for the run conductor.

In certain configurations the run line bolt 906 is a shear bolt having a shearable head 952, a shank 954, and a pressure bar 956. The shank can include a thread and be threadably connected to the run line cap. The pressure bar 956 can be rotatably connected to the shank 954 and configured to engage the run conductor. In other configurations, the run line bolt 906 is a non-shear bolt.

In certain configurations, the pressure bar 956 can include a set of insulation piercing members 958 that extend from the pressure bar 956 toward the insulation piercing members 926 of the run line opening 920. In the illustrated configuration, the pressure bar insulation piercing members 958 include a plurality of teeth extending in an arc. Other configurations can also be used.

The conductor block 902 can include multiple tap openings 908 for allowing connections to be formed with tap conductors. In certain configurations, the first side portion 916 and the second side portion 918 of the conductor block 902 each include two sets of tap line openings 908. A set of tap insulation piercing members 964, extend into each of the tap line openings 908. The insulation piercing members 964 can be teeth, tines, or other features configured to pierce the insulating jacket of a conductor.

In the illustrated configuration, two bolt openings 988 are provided in communication with each of the tap line openings 908 to receive a pair of tap line bolts 910. The bolt openings 988 can be threaded and sized to accommodate the bolt appropriate for the tap conductor. Fewer or more tap bolt openings 988 can be used as needed. The use of two tap bolt openings 988 can allow each tap line opening 908 to receive two tap lines, one from each side. Certain configurations can utilize an internal divider, as part of the conductor block 902, as needed, to separate each tap line opening 908 into a first and second chamber. This can help a user ensure proper seating of the tap line conductors.

Each tap line bolt 910 can include a head 990 and a shank 992. The shank 992 can include a thread and be threadably connected to the bolt opening 988. The head 990 can be connected to the shank 992 by a shearable connection as discussed with respect to the run line shear bolt 906. In other configurations, the head 990 is a non-shear bolt.

In some configurations, the conductor block 902 body 912 can be modified to connect to other conductor blocks or block extensions to increase the number of tap lines that can be connected to the block 902. For example, the body 912 can include mating features, such as male and female mating features that can allow other blocks or extensions to be added on in the field as needed. These could be connected to the bottom of the block to add additional tap openings 908 to connect off of the existing run opening 920.

The foregoing detailed description of the certain exemplary configurations and implementations has been provided for the purpose of explaining the general principles and practical application, thereby enabling others skilled in the art to understand the disclosure for various embodiments and with various modifications as are suited to the particular use contemplated. This description is not necessarily intended to be exhaustive or to limit the disclosure to the exemplary embodiments disclosed. Any of the embodiments and/or elements disclosed herein may be combined with one another to form various additional embodiments not specifically disclosed. Accordingly, additional embodiments are possible and are intended to be encompassed within this specification and the scope of the appended claims. The specification describes specific examples to accomplish a more general goal that may be accomplished in another way.

As used in this application, the terms “front,” “rear,” “upper,” “lower,” “upwardly,” “downwardly,” and other orientational descriptors are intended to facilitate the description of the exemplary embodiments of the present disclosure, and are not intended to limit the structure of the exemplary embodiments of the present disclosure to any particular position or orientation. Terms of degree, such as “substantially” or ˜41˜“approximately” are understood by those of ordinary skill to refer to reasonable ranges outside of the given value, for example, general tolerances associated with manufacturing, assembly, and use of the described embodiments. Unless specified or limited otherwise, the terms “mounted,” “connected,” “supported,” and “coupled” and variations thereof are used broadly and encompass both direct and indirect mountings, connections, supports, and couplings.

Functionality described herein as being performed by one component may be performed by multiple components in a distributed manner. Likewise, functionality performed by multiple components may be consolidated and performed by a single component. Similarly, a component described as performing particular functionality may also perform additional functionality not described herein. For example, a device or structure that is “configured” in a certain way is configured in at least that way but may also be configured in ways that are not explicitly listed.

What is claimed:

1. An electrical connector for connecting a plurality of conductors comprising:
a conductor block having a body with a run line opening, a run insulation piercing member extending into the run line opening, a tap line opening, and a tap insulation piercing member extending into the tap line opening;
a run cap extending over the run line opening;
a run bolt extending through the run cap into the run line opening, wherein the run bolt includes a first threaded shank and a first shearable head, wherein the first shearable head is configured to disconnect from the first threaded shank on reaching a first torque limit;
a tap cap extending over the tap line opening; and
a tap bolt extending through the tap cap into the tap line opening, wherein the tap bolt includes a second threaded shank and a second shearable head, wherein the second shearable head is configured to disconnect from the second threaded shank on reaching a second torque limit.

2. The electrical connector of claim 1, wherein the run insulation piercing member is integrally formed with the conductor block.

3. The electrical connector of claim 1, wherein the run cap is removably connected to the conductor block.

4. The electrical connector of claim 1, wherein the run cap is slidably connected to the conductor block.

5. The electrical connector of claim 1, wherein the tap cap is removably connected to the conductor block.

6. The electrical connector of claim 1, wherein the run insulation piercing member includes a set of teeth.

7. The electrical connector of claim 1, wherein the run bolt includes a pressure bar connected to the first shank.

8. The electrical connector of claim 1, wherein the tap opening is a first tap opening, the conductor block further comprises a second tap opening, and the run opening is positioned between the first tap opening and the second tap opening.

9. The electrical connector of claim 1, wherein the conductor block has a substantially L-shaped configuration with the body having a run portion and a tap portion extending from the run portion.

10. The electrical connector of claim 1, wherein the tap cap includes a first tap bolt opening receiving the tap bolt and a second tap bolt opening receiving a second tap bolt.

11. An electrical connector for connecting a plurality of conductors comprising:
a conductor block having a body with a run line opening, a run insulation piercing member extending into the run line opening, a run guide slot extending from the run line opening, a tap line opening, a tap insulation piercing member extending into the tap line opening, and a tap guide slot extending from the tap line opening;
a run cap slidably connected to the conductor block via the run guide slot;
a run bolt extending through the run cap into the run line opening, wherein the run bolt includes a first threaded shank and a first shearable head, wherein the first shearable head is configured to disconnect from the first threaded shank on reaching a first torque limit;
a tap cap slidably connected to the conductor block via the tap guide slot; and
a tap bolt extending through the tap cap into the tap line opening, wherein the tap bolt includes a second threaded shank and a second shearable head, wherein the second shearable head is configured to disconnect from the second threaded shank on reaching a second torque limit.

12. The electrical connector of claim 11, wherein the tap opening is a first tap opening, the conductor block further comprises a second tap opening, and the run opening is positioned between the first tap opening and the second tap opening.

13. The electrical connector of claim 11, wherein the conductor block has a substantially L-shaped configuration with the body having a run portion and a tap portion extending from the run portion.

14. The electrical connector of claim 11, wherein the tap opening is a first tap opening, the conductor block further comprises a second tap opening, and the run opening is positioned above the first tap opening and the second tap opening.

15. An electrical connector for connecting a plurality of conductors comprising:
a conductor block having a body with a run line opening, a run insulation piercing member extending into the run line opening, a tap line opening, and a tap insulation piercing member extending into the tap line opening;
a run cap extending over the run line opening;
a run bolt extending through the run cap into the run line opening, wherein the run bolt includes a first threaded shank and a first shearable head, wherein the first shearable head is configured to disconnect from the first threaded shank on reaching a first torque limit; and
a tap bolt extending through the conductor block into the tap line opening.

16. The electrical connector of claim 15, wherein the run insulation piercing member includes a set of teeth.

17. The electrical connector of claim 15, wherein the run bolt includes a pressure bar connected to the first shank.

18. The electrical connector of claim 17, wherein the pressure bar includes a second insulation piercing member.

19. The electrical connector of claim 15, wherein the tap opening is a first tap opening, the conductor block further comprises a second tap opening, and the run opening is positioned between the first tap opening and the second tap opening.

20. The electrical connector of claim 15, wherein the conductor block has a substantially round configuration.
